(19) United States
(12) Patent Application Publication
(10) Pub. No.: US 2012/0112658 A1
(43) Pub. Date: May 10, 2012

(54) COLOR TEMPERATURE CONTROL OF FLASH UNITS

(76) Inventors: Hans-Peter Hauser, Rheinfelden (CH); Marcel Griessmann, Steinbach (FR); Martin Buser, Basel (CH); Urs Zeltner, Rodersdorf (CH)

(21) Appl. No.: 12/676,980

(22) PCT Filed: Sep. 9, 2008
(86) PCT No.: PCT/EP08/61896

§ 371 Date: Oct. 12, 2011

(30) Foreign Application Priority Data
Sep. 10, 2007 (DE) 10 2007 043 093.2

(51) Int. Cl. H05B 37/02

(52) U.S. Cl. 315/294

(57) ABSTRACT

A flash unit (1) with a flash generator (20) with at least one energy store (21) and at least two luminaire channels and with at least two flash tubes (11, 12, 13), wherein the flash tubes (11, 12, 13) are supplied with energy by the energy store (21) via the luminaire channels, with an energy quantity control apparatus (14), by means of which any desired quantity of energy from the minimum charge up to the maximum charge of the at least one energy store (21) can be provided for each luminaire channel, and with a colour temperature control apparatus (15), by means of which a coloured temperature can be set for each luminaire channel independently of the quantity of energy provided therefor, and a corresponding method therefor.

The invention relates to a flash unit in accordance with the precharacterizing clause of patent claim 1 and to a method of controlling flash units in accordance with the precharacterizing clause of patent claim 17.

In photography, flash units have already long been used for uniformly illuminating a subject independently of the external light conditions, there being ignited in a flash tube a flash in which an energy store discharges. It is still relatively simple to control the brightness by means of the amount of light emitted as a whole during the flash. The relatively high energy required for that purpose can be set by charging the capacitors of the energy store to a correspondingly high degree.

Brightness is not the only determining factor for image quality, however; trueness of colour also plays an important role. In this connection the so-called colour temperature has become established as a measure. In physical terms, the colour temperature is defined by means of the integral of the intensity distribution (Planck distribution) of the black body radiation. If, therefore, a light source has, for example, a colour temperature of 5000 K, the best black body model for its radiation intensity is that of a black body of 5000 K.

An illustrative indication of colour temperature is offered by the comparison that ordinary daylight having a colour temperature of about 6500 K also corresponds approximately to the surface temperature of the sun. Higher colour temperatures have higher energy and are shifted towards blueish, while lower colour temperatures are correspondingly red-shifted.

FIG. 6 shows, in diagrammatic form, the variation with time of the colour temperature of a flash discharge. Shortly after the flash has been ignited, the output in the arc and thus also the colour temperature reaches its maximum and then, following the characteristic of the capacitor in the energy store, falls exponentially to lower outputs and reddish colour temperatures. If, as is usual, the entire time interval of the flash discharge shown in FIG. 6 is also smaller than the exposure time, the light-sensitive recording element is ultimately exposed with the colour temperature averaged over time, for example an average of 5500 K.

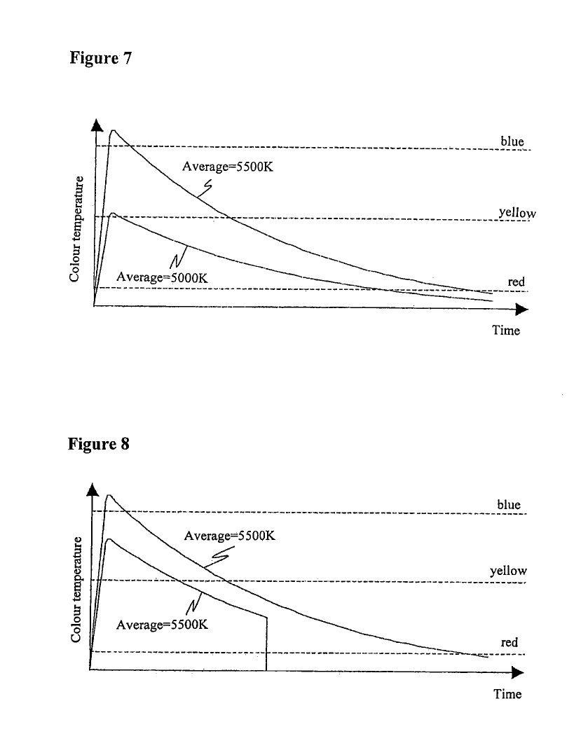

FIG. 7 illustrates the problem of a lack of colour constancy when the amount of light is controlled solely by means of the output of the energy store. The variation with time of the colour temperature of a flash discharge having high energy and having low energy is shown superimposed. It will readily be seen that the average colour temperature of the flash discharge having low energy results in a significantly reduced average colour temperature. The colour temperature is therefore dependent upon the flash energy selected, which is undesirable in use. That effect can also occur when the flash is triggered again before the energy store has been fully recharged.

FIG. 8 shows a method of correcting that undesirable side-effect in which the variation with time of the colour temperature of a relatively low-energy flash discharge nevertheless results in the same average colour temperature as a discharging operation at full energy. The idea lies in compensating for the blueish light components eliminated on account of the relatively low initial output to a suitable extent by eliminating yellowish and reddish components. For that purpose, the flash discharge is stopped prematurely by means of an output switch in the discharge circuit (flash cut-off technique). By a suitable choice of the combination of flash voltage and cut-off timepoint it is accordingly possible for the colour temperature to be kept constant or also to be set freely, independently of the flash energy selected.

On the basis of the flash cut-off technique mentioned above it is possible to achieve good colour temperature stability or regulation. An example of such a flash generator or such a flash unit is known from EP 0 240 789 A1. In the subject of EP 0 240 789 A1, for good colour temperature stability or regulation simultaneous control of the flash time and the flash voltage is provided, which enables the colour temperature to be kept constant or to be controlled.

Despite their good colour temperature stability or regulation, however, multi-channel flash units based on that technique are subject to certain limitations. The flash on a second light source channel, which is connected to a second flash tube, can be controlled only to a limited extent with regulated colour temperature, because the voltage of the second channel is predetermined by the first light source channel having the first flash tube. If the flash durations are the same for channels 1 and 2, the colour temperatures are exactly identical. If the flash durations are different, however, the flash from channel 2 acquires a higher colour temperature. For the user of the unit, usable colour deviation tolerances can be adhered to only as long as the flash duration does not fall below a minimum. That situation has the result that on account of the common denominator of voltage in combination with constant colour temperature only a limited asymmetry is possible. The limitation currently is about three stops and forms the main characteristic of the prior art. If that technique is used in combination with a channel that is not switched off, it is essential that the channel not switched off produces the greater flash. That represents an undesirable limitation of use.

Alternatively to the above-mentioned prior art there is also the technique of capacitor switching. The capacitor switching method likewise exhibits limits in the asymmetry. For economic reasons, only a limited number of capacitors are provided in the corresponding units. This results in a limited asymmetry. For example, for this purpose in the case of a minimum two-channel unit the stop value:

b=[int(log₂(n))]−1 is obtained,

where n is the number of capacitors in circuit.

Using that technique, the asymmetry is limited to three stops, although 16 capacitors are used. The same technique results in further limitations such as, for example, relative limitations from light source channel to light source channel. In particular, that technique results in limitations in the asymmetry in the form of fixed energy distributions. The asymmetry is generally adjustable only in large steps on account of the block switchings of capacitors. In the case of a unit having two light source channels, for example, the following energy distributions are possible:

channel 1 with 40%, channel 2 with 60%, or
channel 1 with 30%, channel 2 with 70%, or
channel 1 with 20%, channel 2 with 80%.

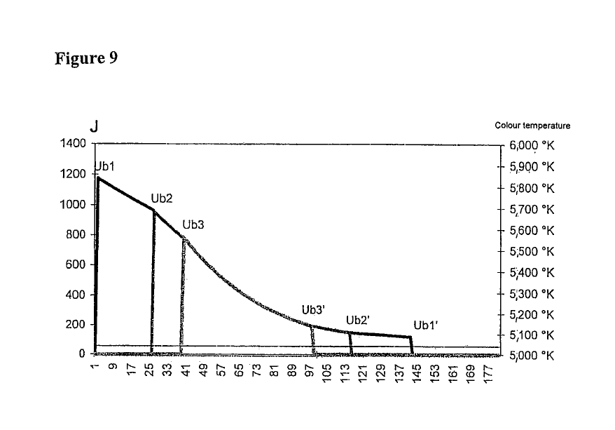

Units which offer intermediate steps achieve this by means of a reduction in the flash voltage. That involves a lowering of the colour temperature, which is again disadvantageous. This is shown in graph form as a colour temperature characteristic curve in FIG. 9. Such a characteristic curve results in non-repeatability in the case of taking photographs, which are noticeable very especially in the case of photographs taken using digital cameras.

Units which have the above-described capacitor cut-off technique in some cases have capacitor block switching devices for coarse setting and other operating elements (for example a control knob) for finer setting. That means that the user (the photographer) needs to be familiar with the internal structure of the unit in order to be able to adjust the unit selectively. In addition, those units have the limitation that the total energy of the energy store is available only by means of the first and/or the second light source channel(s). The further light source channels have only limited possibilities. They can, for example, be supplied with only up to 50% or only up to 25% of the energy available to the generator.

Disadvantageously, therefore, unit-specific knowledge is needed for setting a suitable energy target distribution. An additional shortcoming of such systems is that the use or setting of the generator is dependent upon the number of flash tubes used, i.e. the number of light source channels occupied with flash tubes, which means in turn that the user has to acquire generator-specific knowledge in order to effect the desired settings.

Asymmetries and transpositions or inversions at the light source channels or the light sources also requires a change of connector at the generator. That is disadvantageous especially in professional studios where the generator is often mounted close to the light source (that is to say in particular on the ceiling).

Starting from the prior art described above, the problem of the present invention is to provide a flash generator which allows complete flexibility in use with any desired number of flash tubes controlled thereby, the user not requiring unit-specific knowledge for its operation or setting. A further problem is to define a method which enables the control of a flash unit to be handled with as few complications as possible.

That problem is solved by a flash unit in accordance with claim 1 and by a method of controlling flash units in accordance with claim 17.

An important aspect of the invention is accordingly that a flash unit with a flash generator having at least one energy store and at least two light source channels as well as having at least two flash tubes, which are supplied with energy by the energy store by means of the light source channels, is provided with an energy quantity control device as well as with a colour temperature control device. By means of the energy quantity control device, it is possible to provide for each light source channel any desired energy quantity from the minimum charge to the maximum charge of the at least one energy store. By means of the colour temperature control device, it is possible to set a colour temperature for each light source channel independently of the energy quantity provided therefor. The solution according to the invention provides the prerequisites for illuminating a subject with a plurality of flash tubes with individually selected colour temperature and amount of light. This has the advantage of high flexibility and an optimum range of possible settings for the photographer.

In a preferred embodiment of a flash unit according to the invention, all light source channels are equivalent in respect of their function and their setting. The colour temperature can be identical for all light source channels, while in a further preferred embodiment all light source channels are independent of one another and especially in respect of their function and/or the energy quantity provided therefor can be set separately from one another. If only some of the light source channels are equipped with light sources or flash tubes, the channels so equipped can preferably be freely selectable, because each channel offers exactly the same range of possible settings. By virtue of the above-mentioned structural features, the photographer is assured of an optimum result with, at the same time, convenient handling.

In a further preferred embodiment of a flash unit according to the invention there is provided a trigger device which at a preset timepoint supplies a first light source channel with energy and which at a further number of predetermined timepoints, which are defined by the voltage present at the first light source channel, supplies a respective predetermined number of light source channels with energy. The flash unit according to the invention is optionally equipped with a cut-off device which switches off the first and the further light source channel(s) when a predetermined target energy quantity and/or an averaged target colour temperature has been reached for the respective light source channels. The target colour temperature can especially be an averaged target colour temperature. As a result of such structural measures (especially a trigger device and a cut-off device), an optimum image result is ensured.

Advantageously, there is provided a control means which is arranged to set the ignition and cut-off timepoints of each flash tube in such a way that each flash tube emits light of a preset colour temperature averaged over the time of the flash discharge. With such a flash unit, the user therefore no longer has to rely on setting the ignition and cut-off timepoints but can work immediately with the more descriptive parameter of colour temperature.

Preferably, here the preset colour temperatures are identical. In this special embodiment, therefore, the further flash tubes serve for better illumination of the subject without colour falsification.

Advantageously, the energy store has a plurality of rechargeable energy store elements, especially capacitors. As a result, the energy store can be used more flexibly and can also be used in the event of failure of one of the energy store elements.

Preferably, here the energy store is arranged to connect a plurality of the energy store elements to the flash tubes in parallel for the emission of more charge for a flash or sequentially for a plurality of successive flashes of the flash unit. It is thus possible for the amount of light to be used beyond the capacity of one of the energy store units or to be used a number of times in succession without the need for a charging operation, or naturally in a combination of the two possibilities.

Advantageously, a charging device for the energy store is provided which has a charging control means for introducing a preset charge into one or more of the energy store elements. It is thus possible to set the initial maximum output of the flash discharge and accordingly also the upper limit for the amount of light emitted.

The charging device for setting charging time, charging current and charging voltage can be constructed in such a way that the discharge of the energy store elements by means of the flash tubes produces a preset amount of light in a preset discharge time at a preset colour temperature, it being necessary to note here that the charging device can preset only respective maximum values for the amount of light and the colour temperature, because this naturally depends upon the ignition and cut-off timepoints. In any case, however, a corresponding charge state of the energy store elements is necessary in order to provide any scope at all for configuration of the later time-related control.

Advantageously, the energy store is housed in a generator and the flash tubes in a light source. The energy supply and the actual flash unit are thus separated from one another and are accordingly easier to transport and to maintain.

More advantageously, the time control means and the charging control means are housed in respective modules or in a common module and the generator and/or the light source has(have) a connection for the modules. Those control modules provide for a high degree of flexibility in that, for example, the modules can be interchanged without problems and can also be re-configured independently of the flash unit. This also renders the flash unit more flexible and easier to maintain.

Flash control can optionally be effected by means of a cut-off means or by means of a combination of an ignition delay means and a/the cut-off means. The flashes produced optionally are or are caused to be centred, superimposed or generated in series. This too provides an optimum image result.

The problem posed by the present invention is solved in terms of the method aspect by a method in accordance with patent claim 17. That method relates to the control of a flash unit having at least one energy store and at least two light source channels as well as having at least two flash tubes, each associated with a respective light source channel, which are excited to emit light by the discharge of the energy store. An important aspect of the method according to the invention is that any desired energy quantity is set for each flash discharge of each flash tube or each light source channel and that a colour temperature is set for each flash discharge independently of the energy quantity provided therefor. The advantages are obtained analogously to the device according to the invention.

The flash unit can additionally have a third and/or further flash tube(s), the flash discharges of the third and/or further flash tube(s) being delayed in time with respect to that of the first flash tube, and the cut-off timepoint for the flash discharge of the third and/or further flash tube(s) being set independently of that of the first flash tube. It would equally be possible to set the ignition and cut-off timepoints of each flash tube so that each flash tube emits light of a preset colour temperature averaged over the time of the flash discharge. In a preferred embodiment, the preset colour temperatures are identical, while the flash discharges of the flash tubes are able to produce a preset amount of light in a preset discharge time at a preset colour temperature.

The invention will be described below also in respect of further features and advantages on the basis of exemplary embodiments and referring to the accompanying drawings, wherein

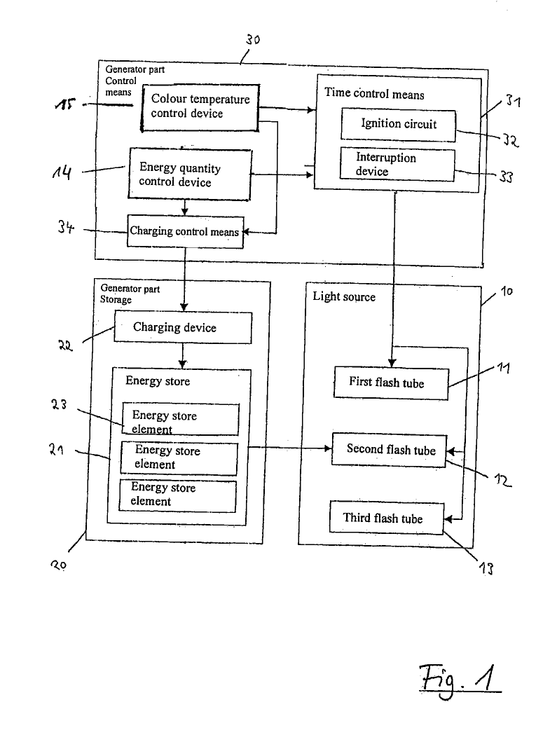

FIG. 1 shows an embodiment of the flash unit according to the invention;

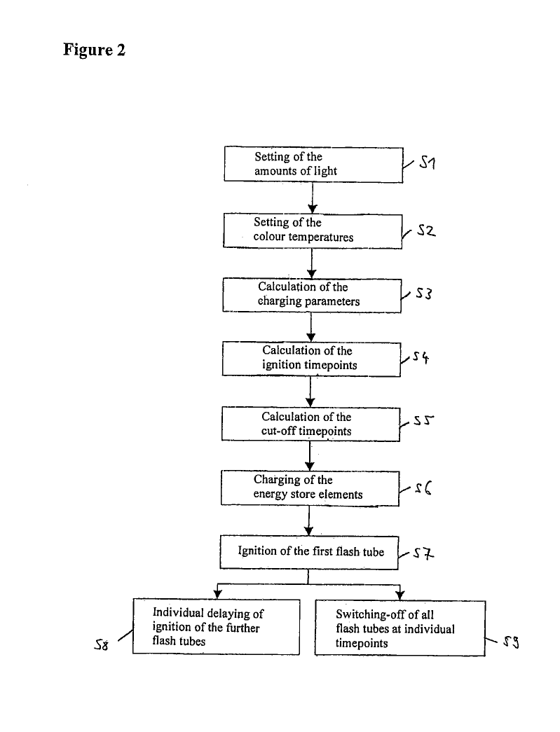

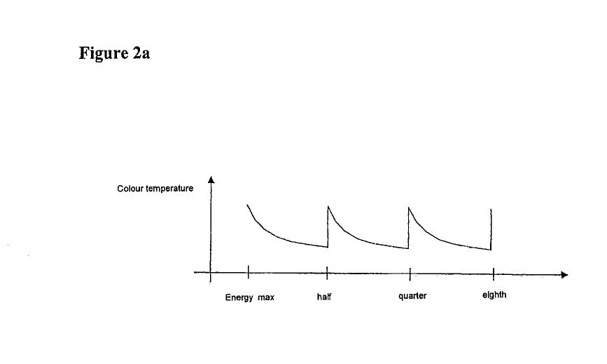

FIG. 2 shows an embodiment of the method according to the invention for controlling a flash unit, for example in accordance with FIG. 1;

FIG. 2a shows the variation with time of the output energy of the flash unit according to the invention for different light source channels;

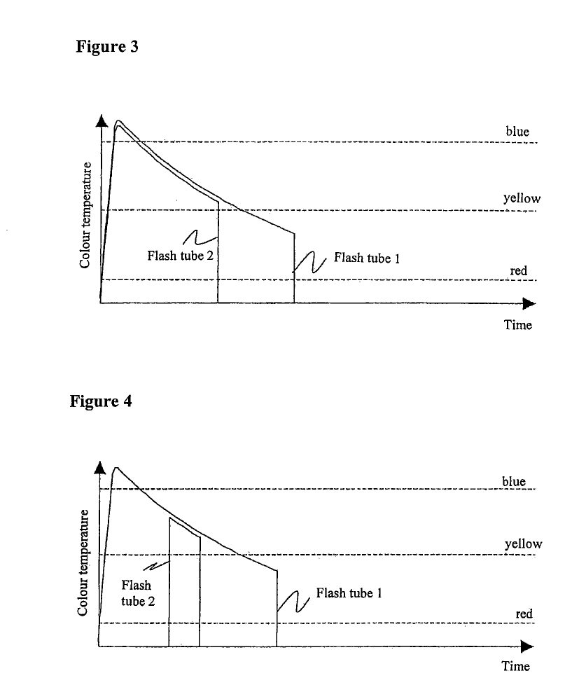

FIG. 3 shows the variation with time of the colour temperature of a flash discharge in a flash unit according to the invention in an especially simple configuration of the ignition and cut-off timepoints;

FIG. 4 shows the variation with time of the colour temperature of a flash discharge in a flash unit according to the invention in which the colour temperatures of the individual flash tubes are identical to one another;

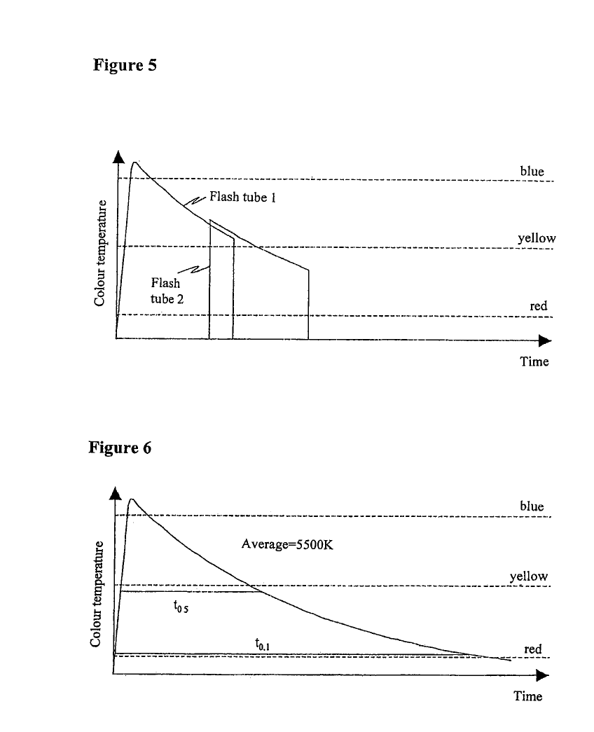

FIG. 5 shows the variation with time of the colour temperature of a flash discharge in a flash unit according to the invention in which the colour temperature of one flash tube is deliberately selected to be different from that of the other flash tube;

FIG. 6 is a general diagram illustrating the variation with time of the colour temperature in the case of a flash discharge;

FIG. 7 shows, superimposed, the variation with time of the colour temperature of two flash discharges which result in different average colour temperatures; and

FIG. 8 is a diagram in accordance with FIG. 7, in which the average colour temperature of one flash discharge has been compensated using a conventional method.

FIG. 9 is a diagram showing the energy curve at the energy store during a flash operation.

FIG. 1 shows an embodiment of the flash unit 1 according to the invention. In a light source 10 of the flash apparatus 1 there are arranged a first, a second and a third flash tube 11-13 which can be, for example, xenon tubes. A generator 20 of the flash unit 1 has an energy store 21 in which energy store elements 23 can be charged with electrical energy by means of a charging device 22.

The flash unit 1 according to the invention also has an energy quantity control device 14 and a colour temperature control device 15. By means of the energy quantity control device 14, any desired energy quantity from the minimum charge to the maximum charge of the energy store 21 can be provided individually for each light source channel, i.e. for each flash tube 11-13. By means of the colour temperature control device 15, it is possible to set a colour temperature for each light source channel, i.e. for each flash tube 11 to 13, independently of the energy quantity provided for the respective flash tube 11-13. An exemplary curve of the energy output quantities of the flash unit 1, i.e. of the flash generator 20, is shown in FIG. 2a. It should be mentioned at this point that all light source channels, that is to say therefore all channels for the flash tubes 11-13, are equivalent in respect of their function and their setting. Furthermore, they can be set independently of one another and, especially in respect of their function or the energy quantity provided therefor, separately from one another.

As energy store elements 23 there are used capacitors, the total capacity of an energy store element possibly being multiplied by parallel connection of a plurality of capacitors. The energy store 21 is connected to the flash tubes 11-13 in order to supply them with electrical energy for a flash discharge. The charging device 22 is capable of charging the energy store elements 23 with a preset charge, the charge in the energy store elements 23 being controllable by means of charging current, charging voltage and charging time. Handling is simplest when, at a preset charging voltage, the charging time is selected to be such that an equilibrium is able to develop.

The energy store 21 can be connected to the flash tubes 11-13 in such a way that only some of the energy store elements 23 feed the flash discharge. As a result, immediately after a flash discharge it is possible to trigger a further flash discharge with the aid of energy store elements not previously used. At the same time it is possible for discharged energy store elements 23 to be re-charged during a flash discharge that is being fed by other energy store elements 23.

In a control means 30 of the flash unit 1, the times of the flash discharge in the flash tubes 11-13 can be fixed by means of a time control means 31. For that purpose, the time control means 31 is provided with an ignition circuit 32 and a cut-off device in the form of an interruption device 33 which are each able to actuate each of the flash tubes 11-13 individually. The ignition circuit 32 can therefore make the connection between the energy store 21 and each individual flash tube 11-23, while the interruption device 33 interrupts that connection in order to extinguish the flash, the time control means 31 being arranged to calculate suitable ignition and cut-off timepoints for preset amounts of light and colour temperatures.

A charging control means 34 of the control means 30 is connected to the charging device 22 of the generator 20. The charging control means 34 is capable of calculating the above-mentioned charging parameters of the charging device 22 for the desired maximum amount of light.

The function of the described flash unit 1 will now be explained on the basis of a description of the method according to the invention, as shown in FIG. 2. If, first of all, the flash parameters are to be set, in a first step S1 the desired energy quantities or amounts of light are fixed individually for each flash tube 11-13. That can be effected by a user, but also automatically, for example, taking into account the external light conditions detected by sensors. In a next step S2, the desired colour temperatures for each individual flash tube 11-13 are set by the user or automatically in a corresponding way.

In a third step S3, the charging control means 34 calculates the charging parameters for the charging device 22 on the basis of the desired amounts of light and colour temperatures. In steps S4 and S5, the time control means 31 calculates the individual ignition and cut-off timepoints of each individual flash tube 11-13, the cut-off timepoints of the second and third flash tubes being calculated as a delay with respect to the first flash tube. The first flash tube therefore forms the time reference point which is determined, for example, by the triggering of a photograph.

The control means 30 has now been set ready for the use of the flash unit 1. It will be understood that the setting of the parameters need not be carried out afresh for each flash. Instead, the flash unit can be used with the parameters now calculated for as long as desired and for any desired number of flashes. It would also be possible for the control means 30 to be of substantially simpler construction and to have no capability at all for actually calculating the flash parameters on the basis of the total amount of light and the colour temperature. In that case, there are simply provided a plurality of schemes for charging voltage and ignition and cut-off timepoints. The user can then make a selection from those fixed schemes, which can also be selected by more illustrative names (for example “daylight, bright”) than by fixing the physical parameters of amount of light and colour temperature.

In a further step S6, which in the case of the fixed preset parameter scheme can also be the first step, the energy store elements 23 in the energy store 21 are charged by the charging device 22. From that moment on, the flash unit is ready for use and when a flash is triggered, the first flash tube is ignited, step S7.

From that timepoint on, the time control means 31 simultaneously monitors whether the delay interval for the ignition of a further flash tube 11, 12 has elapsed since the ignition of the first flash tube. In that case, the further flash tube 11, 12 is also ignited. At the same time, all flash tubes are monitored as to whether the cut-off timepoint has been reached and therefore the connection to the energy store 21 of the flash tube 11-13 in question has to be interrupted in order to extinguish the flash.

For further use of the flash unit 1, the cycle is repeated either using the same flash parameters in step S6 with the charging of the energy store elements 23 and possibly with the use of other, still charged store elements 23, or using modified flash parameters with the amounts of light and colour temperatures being set afresh.

FIGS. 3 to 5 show, in diagrammatic form, various application scenarios of the flash unit 1 according to the invention. The Figures show, superimposed, the variation with time of the colour temperatures of two flash tubes, only two flash tubes being shown here for the purpose of simplification. FIG. 3 shows the simplest case, in which the flash tube 2 is merely switched off with a delay with respect to the flash tube 1. This has the result that the flash tube 2 emits a larger amount of light but that at the same time, on account of the higher yellow components, the flash tube 2 has a lower colour temperature than the flash tube 1.

In FIG. 4, however, the ignition timepoint of the flash tube 2 is delayed with respect to the flash tube 1 and at the same time the cut-off timepoint is selected to be early so that the average of the colour temperature of the two flash tubes over time is identical, the flash tube 2, in accordance with the substantially smaller area in FIG. 4, emitting a smaller amount of light.

FIG. 5 shows that according to the invention it is also possible, with a delayed ignition timepoint of the flash tube 2, deliberately to select a different average colour temperature with respect to the flash tube 1.

The flash unit according to the invention therefore enables the brightness and colour temperature of a plurality of flash tubes to be selected individually. In summary, it can be stated that the flash unit according to the invention is capable of delivering any desired energy level to any desired light source channel, i.e. to any desired flash tube. With this unit structure it is possible to deliver the total energy of the energy store 21 by means of any light source channel. It is also possible to set for the respective light source channels an energy quantity between 0 and 100% of the energy available in the energy store 21 or the flash generator 20, independently of the values set in the secondary channels, it being understood that the sum of the values set over the channels may not be greater than the energy available in the energy store 21. In addition, the energies are so controlled (current curve, voltage curve and variation with time) that the resultant flashes have the same colour temperature from channel to channel. At the same time, for each light source channel the colour temperature can be regulated and set independently of the energy quantity selected for the flash. This has the advantage inter alia that the light source connectors no longer have to be exchanged when an asymmetry is to be, for example, reversed or inverted. This saves time and difficult handling for the user. A further advantage is that the operation of such a flash generator 20, i.e. such a flash unit 1, does not require specific knowledge or understanding of the generator structure. That is especially of advantage in the case of hire businesses where the simplicity allows easy initial set-up and where the hire time is being paid for. With this structure there are no limitations or internal conditions which have to be taken into consideration during setting. Because the functions of all light source channels are fully equivalent, any channel can be connected without other light sources or flash tubes being connected.

Asymmetries can be simply inverted by means of pushbutton selection, without the need to manipulate light source cables or to operate a plurality of operating elements. That flexibility can be achieved by selecting the voltage ranges of the flashes to be generated in such a way that the energy quantity supplied to the flash tube at those voltages produces a colour temperature that is constant or has a selected value. To implement the method it is necessary that, during the first flash (blue when the precalculated voltage Ub2 has been reached (see in this connection FIG. 2a)), the second flash be triggered voltage-shifted. Accordingly, the third flash is likewise triggered when the voltage Ub3 has been reached. When Ub3 has been reached, the flash operation is active on three channels. That operation or that method can also be used for a higher number of channels.

The end of the flash is controlled in accordance with a flash cut-off operation, it being necessary to note that that alone does not allow the same colour temperature to be reached. The method according to the invention has the advantage of theoretically unlimited asymmetry. The prior art of three stops becomes theoretically unlimited and depends only upon the implementation quality or accuracy. The colour temperature can be regulated channel-specifically. At the same time, the energy quantity can be freely determined for each channel.

With the multi-channel flash units according to the invention it is therefore possible for a plurality of flashes to be produced simultaneously, that is to say with at least one superimposition of the flashes (in a photographic sense).

Although the invention has been described on the basis of the above-mentioned exemplary embodiments, it also comprises further advantageous combinations of the mentioned features.

### LIST OF REFERENCE NUMERALS

1 flash unit
10 light source
11 first flash tube
12 second flash tube
13 third flash tube
14 energy quantity control device
15 colour temperature control device
20 generator
21 energy store
22 charging device
23 energy store element
30 control means
31 time control means
32 ignition circuit
33 interruption device
34 charging control means

1. Flash unit (1) with a flash generator (20) having at least one energy store (21) and at least two light source channels as well as having at least two flash tubes (11, 12, 13), the flash tubes (11, 12, 13) being supplied with energy by the energy store by means of the light source channels,
characterized by
an energy quantity control device (14), by means of which it is possible to provide for each light source channel any desired energy quantity from the minimum charge to the maximum charge of the at least one energy store (21), and
a colour temperature control device (15), by means of which it is possible to set a colour temperature for each light source channel independently of the energy quantity provided therefor.

2. Flash unit (1) according to any one of the preceding claims,
characterized in that
all light source channels are equivalent in respect of their function and their setting.

3. Flash unit (1) according to any one of the preceding claims,
characterized in that
the colour temperature is identical for all light source channels.

4. Flash unit (1) according to any one of the preceding claims,
characterized in that
all light source channels are independent of one another and especially in respect of their function and/or the energy quantity provided therefor can be set separately from one another.

5. Flash unit (1) according to any one of the preceding claims,
characterized in that
if only some of the light source channels are equipped with flash tubes (11, 12, 13) or light sources, the channels so equipped are freely selectable.

6. Flash unit (1) according to any one of the preceding claims,
characterized by
a trigger device which at a preset timepoint supplies a first light source channel with energy and which at a further number of predetermined timepoints, which are defined by the voltage present at the first light source channel, supplies a respective predetermined number of light source channels with energy.

7. Flash unit (1) according to claim 6,
characterized by
a cut-off device (33) which switches off the first and the further light source channel(s) when a predetermined target energy quantity and/or a target colour temperature, especially an averaged target colour temperature, has been reached for the respective light source channels.

8. Flash unit (1) according to any one of the preceding claims,
characterized in that
the energy store (21) has a plurality of rechargeable energy store elements (23), especially capacitors.

9. Flash unit (1) according to claim 8,
characterized in that
the energy store (21) is arranged to connect a plurality of the energy store elements (23) to the flash tubes in parallel for the emission of more charge for a flash or sequentially for a plurality of successive flashes of the flash unit.

10. Flash unit (1) according to any one of the preceding claims,
characterized in that
a charging device (22) for the energy store (21) is provided which has a charging control means for introducing a preset charge into one or more of the energy store elements (23).

11. Flash unit (1) according to claim 10,
characterized in that
the charging device (22) for setting charging time, charging current and charging voltage is constructed in such a way that the discharge of the energy store elements (23) by means of the flash tubes (11, 12, 13) produces a preset amount of light in a preset discharge time at a preset colour temperature.

12. Flash unit (1) according to any one of the preceding claims,
characterized in that
the energy store (21) is housed in a generator (20) and the flash tubes in a light source (10).

13. Flash unit (1) according to claim 12,
characterized in that
the time control means and the charging control means are housed in respective modules or in a common module and the generator (20) and/or the light source (10) has(have) a connection for the modules.

14. Flash unit (1) according to any one of the preceding claims,
characterized in that
the flash control is effected by means of a cut-off means.

15. Flash unit (1) according to any one of the preceding claims,
characterized in that
the flash quantity control is effected by means of a combination of an ignition delay means and a/the cut-off means.

16. Flash unit (1) according to any one of the preceding claims,
characterized in that
the flashes produced are caused to be centred, superimposed or generated in series.

17. Method of controlling a flash unit (1) having at least one energy store (21) and at least two light source channels as well as having at least two flash tubes (11, 12, 13), each associated with a respective light source channel, which are excited to emit light by the discharge of the energy store (21),
characterized in that
any desired energy quantity is set for each flash discharge of each flash tube (11, 12, 13) and a colour temperature is set for each flash discharge independently of the energy quantity provided therefor.

18. Method according to claim 17,
characterized in that
the flash unit (1) additionally has a third and/or further flash tube(s) (11, 12, 13), and the flash discharges of the third and/or further flash tube(s) (11, 12, 13) are delayed in time with respect to that of the first flash tube (11, 12, 13) and the cut-off timepoint for the flash discharge of the third and/or further flash tube(s) (11, 12, 13) is set independently of that of the first flash tube (11, 12, 13).

19. Method according to either one of claims 17 and 18,
characterized in that
the ignition and cut-off timepoints of each flash tube (11, 12, 13) are set so that each flash tube (11, 12, 13) emits light of a preset colour temperature averaged over the time of the flash discharge.

20. Method according to claim 19,
characterized in that
the preset colour temperatures are identical.

21. Method according to any one of claims 17 to 20,
characterized in that
the flash discharges of the flash tubes (11, 12, 13) produce a preset amount of light in a preset discharge time at a preset colour temperature.

22. Method according to any one of claims 17 to 21,
characterized in that
the flashes produced are caused to be centred, superimposed or generated in series.
